(19) United States
(12) Patent Application Publication
(10) Pub. No.: US 2025/0254489 A1
(43) Pub. Date: Aug. 7, 2025

(54) DISPLAY METHOD, INFORMATION PROCESSING DEVICE, AND PROGRAM

(71) Applicant: Yamaha Corporation, Hamamatsu (JP)

(72) Inventors: Hiromu OHGI, Iwata (JP); Tadashi MORIKAWA, Hamamatsu (JP)

(21) Appl. No.: 19/188,197

(22) Filed: Apr. 24, 2025

Related U.S. Application Data
(63) Continuation of application No. PCT/JP2023/031318, filed on Aug. 29, 2023.

(30) Foreign Application Priority Data
Oct. 25, 2022 (JP) 2022-170705

(51) Int. Cl. H04S 7/00

(52) U.S. Cl. CPC H04S 7/308; H04S 7/301

(57) ABSTRACT

A display method is performed to easily understand a placement of audio equipment for realizing a target sound pressure distribution in an acoustic space. The display method includes receiving an acoustic space and a target sound pressure distribution in the acoustic space. The display method further includes calculating, based on a prescribed model, a placement distribution of speakers or microphones, which corresponds to the target sound pressure distribution, in the acoustic space. The display method further includes displaying the calculated placement distribution.

### CROSS-REFERENCE TO RELATED APPLICATIONS

This application is a continuation application of International Application No. PCT/JP2023/031318, filed on Aug. 29, 2023, which claims priority to Japanese Patent Application No. 2022-170705 filed in Japan on Oct. 25, 2022. The entire disclosures of International Application No. PCT/J P2023/031318 and Japanese Patent Application No. 2022-170705 are hereby incorporated herein by reference.

### BACKGROUND

### Technical Field

This disclosure generally relates to a display method, an information processing device, and a program. Background Information

Japanese Laid-Open Patent Publication No. Hei 5-73081 discloses a sound field simulator that simulates how a sound from a prescribed sound source within a sound field sounds at a prescribed sound receiving point based on design data of the sound field and that creates a simulated sound field in a listening room.

### SUMMARY

Japanese Laid-Open Patent Publication No. Hei 5-73081 does not calculate the placement of audio equipment corresponding to a target sound pressure distribution. For those not having expert knowledge, determining the optimal placement of audio equipment for realizing a target sound pressure distribution is extremely difficult.

An object of one aspect of the present disclosure is to provide a display method by which it is possible to easily understand the optimal placement of audio equipment for realizing a target sound pressure distribution in an acoustic space.

A display method according to one embodiment of this disclosure comprises receiving an acoustic space and a target sound pressure distribution in the acoustic space; calculating, based on a prescribed model, a placement distribution of speakers or microphones, which corresponds to the target sound pressure distribution, in the acoustic space, and displaying the placement distribution.

### BRIEF DESCRIPTION OF THE DRAWINGS

FIG. 1 is a block diagram showing a configuration of an information processing device 1.

FIG. 2 is a flowchart showing an operation of a display method executed by a processor 12.

FIG. 3 is a diagram showing one example of a screen (GUI) of an application program for displaying a placement distribution of speakers as an example of audio equipment.

FIG. 4 is a diagram showing one example of a screen (GUI) of an application program for displaying a placement distribution of speakers as an example of audio equipment.

FIG. 5 is a diagram showing one example of a screen (GUI) of an application program according to another example for receiving a target sound pressure distribution.

FIG. 6 is a diagram showing an example of a display of a speaker placement distribution.

FIG. 7 is a diagram showing an example of a display of a sound pressure distribution.

FIG. 8 is a diagram showing one example of a screen (GUI) of an application program according to a second modified example.

FIG. 9 is a diagram showing one example of a screen (GUI) of an application program according to a fourth modified example.

FIG. 10 is a diagram showing one example of a screen (GUI) of an application program according to the fourth modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

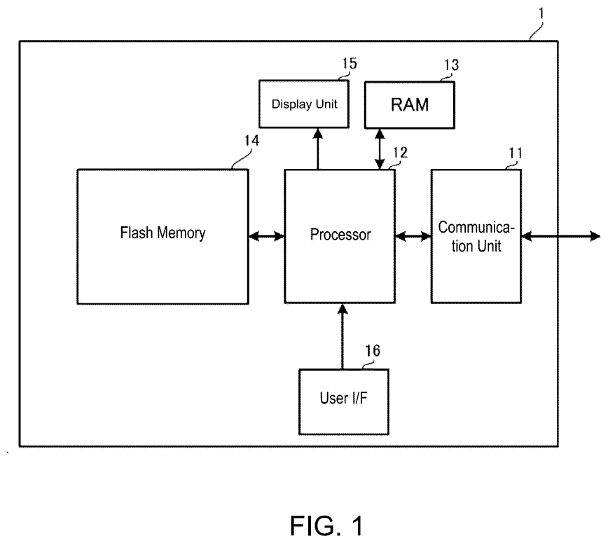

FIG. 1 is a block diagram showing a configuration of an information processing device 1. The information processing device 1 is realized by an information processing device such as a personal computer (PC), a smartphone, a set-top box, or an audio receiver.

The information processing device 1 comprises a communication unit 11, a processor 12, RAM (Random Access Memory) 13, flash memory 14, a display unit 15, a user I/F (Interface) 16.

The communication unit 11 has a wireless communication function such as Bluetooth (registered trademark) or Wi-Fi (registered trademark), or a wired communication function such as USB (Universal Serial Bus) or LAN (Local Area Network). The communication unit 11 can be a transmitter, a transceiver, or a transmitter-receiver capable of transmitting and/or receiving sound signals via a wireless or wired communication.

The display unit 15 is a display such as an LCD (Liquid-Crystal display), and/or an OLED (Organic Light Emitting Diode). The display unit 15 displays an image output by the processor 12.

The user I/F 16 is one example of an operation unit. The user I/F 16 is a user operable input such as a mouse, a keyboard, a touch panel, or the like. The user I/F 16 receives operations from the user. The touch panel can be layered on the display unit 15.

The processor 12 is a processor such as a CPU (Central Processing Unit), a DSP (Digital Signal Processor), a SoC (System on a Chip), and/or the like. The processor 12 is one example included in an electronic controller of the information processing device 1, and the electronic controller can be configured to comprise one or more processors. Here, the term “electronic controller” as used herein refers to hardware, and does not include a human. The processor 12 reads a program from the flash memory 14, which is a storage medium, and temporarily stores the program in the RAM 13 to carry out various operations. It is not necessary for the program to be stored in the flash memory 14. The processor 12 can, for example, download a program from another device, such as a server, when needed, and temporarily store the program in the RAM 13. A computer memory such as RAM 13 and/or flash memory 14 is one example of a non-transitory computer-readable medium.

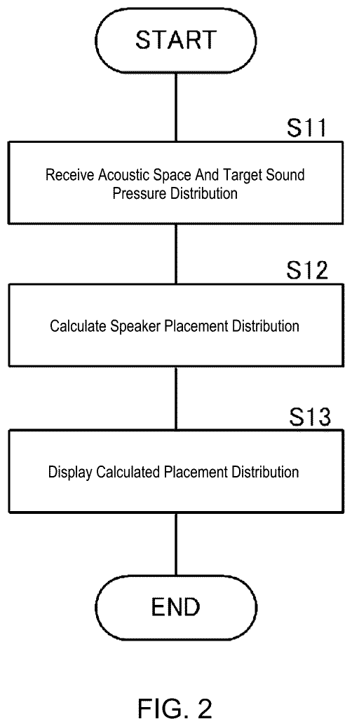

FIG. 2 is a flowchart showing an operation of a display method executed by the processor 12. The processor 12 executes the display method shown in FIG. 2 using an application program read from the flash memory 14.

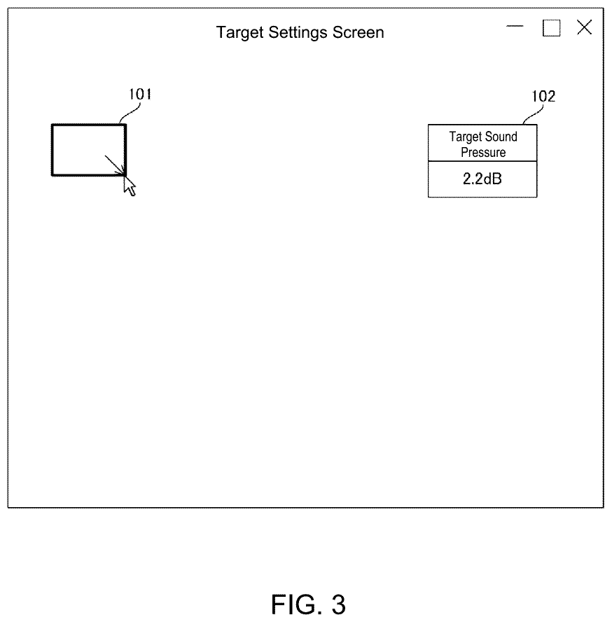

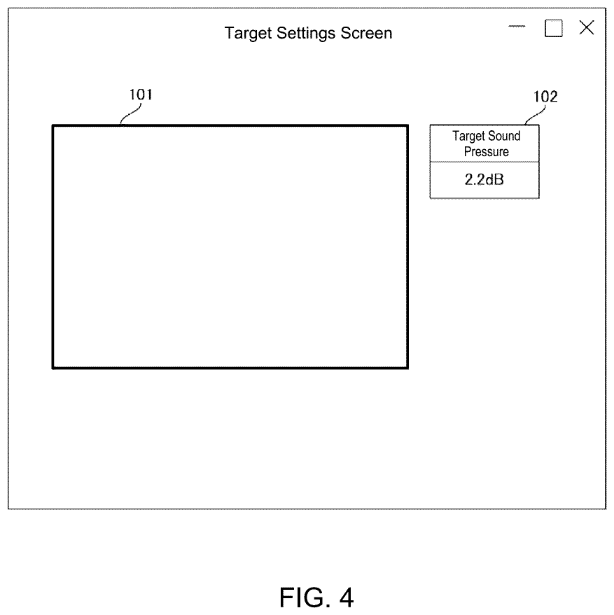

First, the processor 12 receives an acoustic space and a target sound pressure distribution in the acoustic space (S11). FIGS. 3 and 4 are diagrams each showing an example of a screen (GUI) of an application program for displaying a placement distribution of speakers as an example of audio equipment. The processor 12 displays, on the display unit 15, a target settings screen such as that shown in FIG. 3, and receives, from a user via the user I/F 16, an acoustic space and a target sound pressure distribution in the acoustic space.

The GUI shown in FIG. 3 or 4 includes an acoustic space interface 101 and a target setting interface 102. The user sets an acoustic space via the acoustic space interface 101. For example, the user moves a mouse cursor on the GUI to a starting position and performs a click-and-drag operation to draw a rectangle. As a result, in the example shown in FIGS. 3 or 4, the user sets an acoustic space that is rectangular in plan view.

In the present embodiment, an example is shown in which a two-dimensional acoustic space as viewed in plan view is set, but a one-dimensional acoustic space along a certain direction can be set, or a three-dimensional acoustic space including a height direction can be set. The user sets a straight line or a curved line as a one-dimensional acoustic space. The user sets, as a two-dimensional acoustic space, a two-dimensional plane formed of straight lines, a two-dimensional plane formed of curved lines, or a composite two-dimensional plane formed by straight and curved lines. The user sets, as a three-dimensional acoustic space, a polyhedron formed of polygons, a cylindrical or a conical shape including a curved surface, or a spherical shape.

The setting of an acoustic space by drawing using a mouse cursor shown in FIG. 3 is merely an example; the application program can receive an acoustic space via any type of interface. For example, the user can input a name of an existing concert hall, etc., and the application program can receive the shape of the acoustic space based on 3D CAD data corresponding to the concert hall that was input.

In addition, the user inputs a target sound pressure distribution in the set acoustic space via the target setting interface 102. In the example shown in FIGS. 3 or 4, the user has input a numerical value of 2.2 dB as the target sound pressure. In the example shown in FIGS. 3 or 4, the application program receives, as the target sound pressure distribution, an average sound pressure of the acoustic space set in the acoustic space interface 101, as an example.

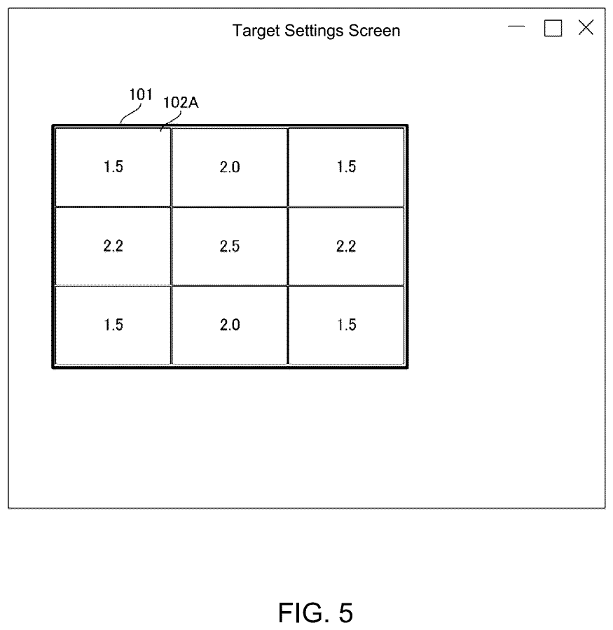

However, the application program can also receive a different sound pressure for each position in the acoustic space interface 101. For example, FIG. 5 is a diagram showing one example of a screen (GUI) of an application program according to another example for receiving a target sound pressure distribution. In the example shown in FIG. 5, the application program divides an acoustic space set in the acoustic space interface 101 into a plurality (nine in the example of FIG. 5) of sound pressure setting regions 102A. The user inputs a target sound pressure for each of the plurality of sound pressure setting regions 102A.

Next, the processor 12 calculates, based on a prescribed model, a speaker placement distribution corresponding to the target sound pressure distribution that was received, in the acoustic space that was received (S12). The processor 12 uses a mathematical model or a trained model to obtain the speaker placement distribution. The trained model is a model trained on the relationship between sound pressure distribution and speaker placement distribution using a deep neural network (DNN).

A computer (for example, a server of a speaker manufacturer) that generates the trained model acquires, in a training stage, a large number of datasets of sound pressure distributions when certain speakers having certain output characteristics are installed in a certain acoustic space. The server uses the large number of datasets that were acquired to train a prescribed model on the relationship between the speaker placement distribution and the sound pressure distribution using a prescribed algorithm.

Any algorithm can be used to train the model. A ny machine learning algorithm, such as a convolutional neural network (CNN) or a recurrent neural network (RNN) can be used for the algorithm.

When certain speakers having certain output characteristics are placed in a certain prescribed acoustic space, the speaker placement distribution and the sound pressure distribution in said acoustic space are uniquely determined. That is, the speaker placement distribution in a certain acoustic space and the sound pressure distribution in said acoustic space are correlated. Accordingly, the server can train the prescribed model on the relationship between the speaker placement distribution in a certain acoustic space and the sound pressure distribution in said acoustic space to generate a trained model.

The processor 12 acquires the trained model trained in the manner described above from the server via the communication unit 11. In the execution stage, the processor 12 inputs the acoustic space that was received and the target sound pressure distribution in said acoustic space and calculates the corresponding speaker placement distribution using the trained model.

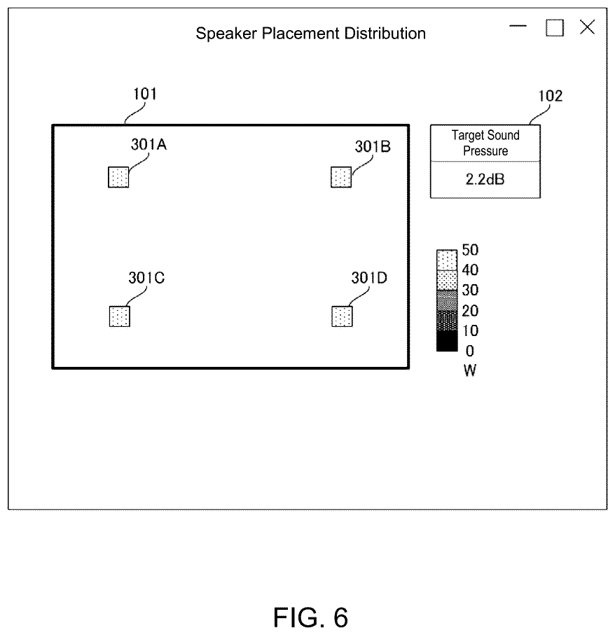

Then, the processor 12 displays the calculated speaker placement distribution on the display unit 15 (S13). FIG. 6 is a diagram showing an example of a display of a speaker placement distribution. The processor 12 displays the speaker placement distribution calculated in the process of S12 in the acoustic space set in the acoustic space interface 101. The speaker placement distribution indicates at least the number and positions of the speakers in the acoustic space. The example shown in FIG. 6 displays four speakers 301A, 301B, 301C, 301D in a rectangular acoustic space. The speaker 301A is displayed at a position close to the upper left corner, the speaker 301B is displayed at a position close to the upper right corner, the speaker 301C is displayed at a position close to the lower left corner, and the speaker 301D is displayed at a position close to the lower right corner.

In addition, the processor 12 can display output characteristics (W) of the speaker as a part of the speaker placement distribution. For example, in the example shown in FIG. 6, the output characteristics of the speakers are shown by an indicator. For example, in FIG. 6, all of the four speakers 301A, 301B, 301C, 301D are displayed as speakers having output characteristics of 40 to 50 W.

The user can thereby easily understand where and how many speakers should be installed in order to obtain the target sound pressure distribution in the set acoustic space, providing a new customer experience. In addition, the user can easily understand what type of output characteristics the speakers to be installed should have, providing a new customer experience.

### First Modified Example

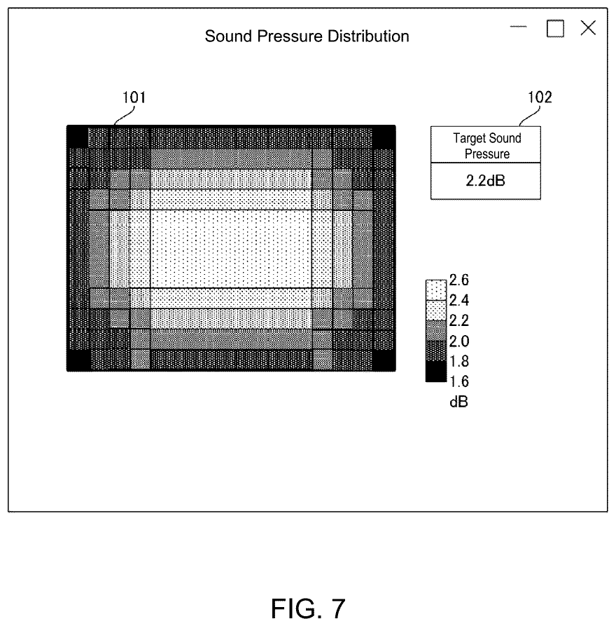

The processor 12 according to the first modified example calculates the sound pressure distribution corresponding to the calculated speaker placement distribution. Specifically, the processor 12 uses the calculated output characteristics of each speaker and the sound pressure characteristics that attenuate inversely proportional to the square of distance to calculate the sound pressure at each position in the acoustic space. Then, the processor 12 displays the calculated sound pressure distribution on the display unit 15. FIG. 7 is a diagram showing an example of a display of a sound pressure distribution.

The processor 12 shows, as the sound pressure distribution, the sound pressure at each position in the acoustic space using an indicator. In the example shown in FIG. 7, the central position in the acoustic space is a position surround by the four speakers 301A, 301B, 301C, 301D, thereby having high sound pressure. The four corners of the acoustic space have relatively low sound pressure.

As a result, the user can easily understand what kind of sound pressure distribution would result from the calculated speaker placement distribution, providing a new customer experience.

### Second Modified Example

In the second modified example, the processor 12 receives a first space for specifying a target sound pressure distribution, and a second space for installing speakers. That is, in the second modified example, the acoustic space set by the user includes a first space for specifying a target sound pressure distribution, and a second space for installing speakers.

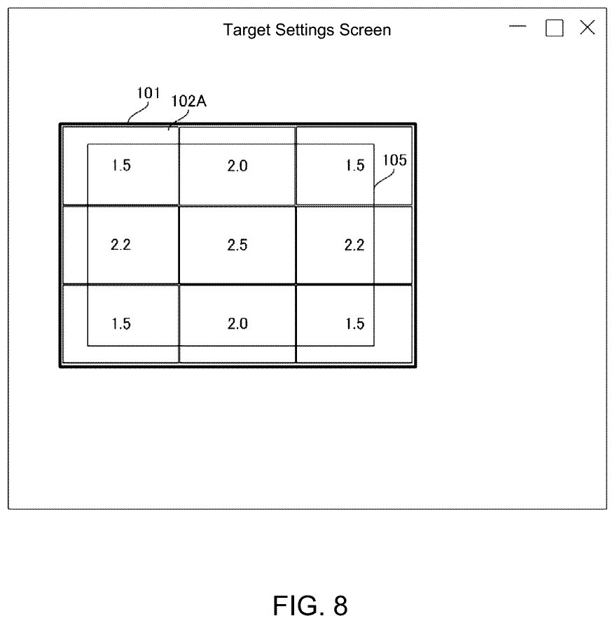

FIG. 8 is a diagram showing one example of a screen (GUI) of an application program according to the second modified example. The processor 12 further displays an installation space interface 105 for installing speakers inside the acoustic space interface 101 for receiving a target sound pressure distribution. The user sets the target sound pressure distribution (first space) via the acoustic space interface 101 and a sound pressure setting region 102A, and further sets a second space for installing speakers via the installation space interface 105. For example, in an actual concert hall, there are limited places in the acoustic space where audio equipment, such as speakers, can be installed, such as wall surfaces, ceilings, and pillars. The user sets a second space for installing speakers therein, in consideration of places where audio equipment can be installed within an actual concert hall.

Alternatively, the user can input a name of an existing concert hall, etc., and the application program can receive the shapes of wall surfaces, ceiling surfaces, or pillars based on 3D CAD data of the concert hall that was input, to receive the space for installing speakers therein.

The user can thereby easily understand the optimal speaker placement in a situation in which there are limited places in the acoustic space where speakers can be installed, providing a new customer experience.

### Third Modified Example

The processor 12 according to the third modified example receives information related to the directivity of speakers and calculates the speaker placement distribution based on the information related to the directivity of speakers.

In this case, the server acquires, in a training stage, a large number of sound pressure distributions when speakers having certain output characteristics and certain directivity are installed in a certain acoustic space. The server causes a prescribed model to be trained, using a prescribed algorithm, on the relationship between the speaker placement distribution, the directivity of the speakers, and the sound pressure distribution.

The processor 12 acquires the trained model trained in the manner described above from the server via the communication unit 11. In the execution stage, the processor 12 inputs the acoustic space that was received, the target sound pressure distribution in said acoustic space, and the information related to the directivity of the speakers, and obtains the corresponding speaker placement distribution using the trained model.

The user can thereby easily learn of more optimal speakers that take directivity into consideration, providing a new customer experience.

### Fourth Modified Example

The processor 12 according to the fourth modified example receives the number and positions of fixed speakers fixed in an acoustic space inside a venue, such as a concert hall, and further calculate the speaker placement distribution based on the number and positions of the fixed speakers.

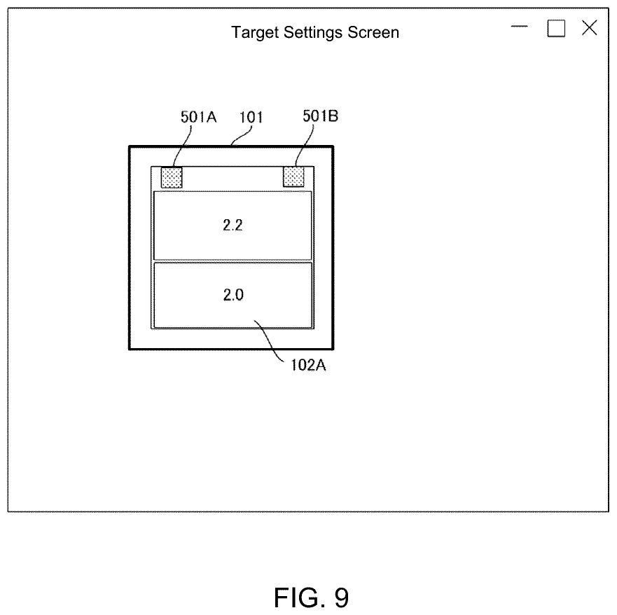

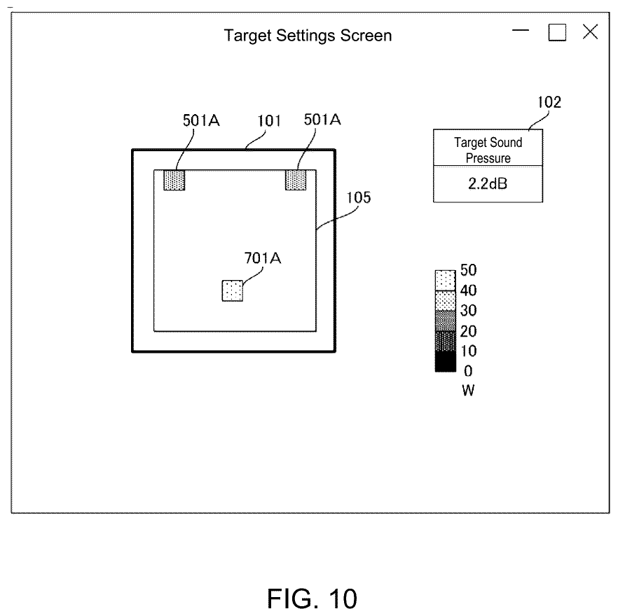

FIGS. 9 and 10 are diagrams showing examples of a screen (GUI) of an application program according to the fourth modified example. The user further sets the number of fixed speakers and values in the acoustic space interface 101. In the example shown in FIG. 9, the processor 12 receives a fixed speaker 501A in the upper left and a fixed speaker 501B in the upper right of a square acoustic space received via the acoustic space interface 101.

The processor 12 inputs the acoustic space that was received and the target sound pressure distribution in said acoustic space and obtains the corresponding speaker placement distribution using the trained model, with the output characteristics of the fixed speakers 501A and 501B that were received as constraint conditions.

As a result, the processor 12 displays, in addition to the fixed speakers 501A and 501B, a speaker 701A that is required to obtain the target sound pressure distribution, as shown in FIG. 10.

As a result, the user can easily understand the optimal placement of auxiliary speakers in the audience seating areas, etc., in the set acoustic space in consideration of speakers that are pre-installed as a part of the facility of a concert hall, etc., providing a new customer experience.

The description of the present embodiment is exemplary in all respects and should not be considered restrictive. The scope of the present invention is indicated by the Claims section, not the embodiment described above. Furthermore, the scope of the present invention includes the scope that is equivalent that of the Claims.

For example, speakers are used as the audio equipment in the description above, but all of the “speakers” in the description above can be replaced with “microphones.” In the case that microphones are the audio equipment, the processor 12 can receive an acoustic space and a target sound pressure distribution (gain characteristics) in said acoustic space, calculate a microphone placement distribution corresponding to the target sound pressure distribution that was received in the acoustic space that was received based on a prescribed model, and display the calculated placement distribution on the display unit 15. In addition, the “output characteristics of the speakers” in the description above can all be replaced with “input characteristics of the microphones.” The “fixed speakers” in the description above can be replaced with “fixed microphones.” Regarding microphones as well, the user can easily understand how many microphones should be installed and in which positions in order to obtain the target sound pressure distribution (gain characteristics) in the set acoustic space, providing a new customer experience. In addition, the user can easily understand what type of input characteristics the microphones to be installed should have, providing a new customer experience.

### Effects of the Invention

According to one embodiment of the present invention, a user can easily understand the optimal placement of audio equipment for realizing a target sound pressure distribution in an acoustic space.

What is claimed is:

1. A display method comprising:
receiving an acoustic space and a target sound pressure distribution in the acoustic space;
calculating, based on a prescribed model, a placement distribution of speakers or microphones, which corresponds to the target sound pressure distribution, in the acoustic space; and
displaying the placement distribution.

2. The display method according to claim 1, wherein
the placement distribution indicates the number and positions of the speakers or the microphones in the acoustic space.

3. The display method according to claim 1, wherein
the placement distribution includes output characteristics of the speakers or input characteristics of the microphones.

4. The display method according to claim 1, wherein
the acoustic space includes a first space for specifying the target sound pressure distribution, and a second space for installing the speakers or the microphones.

5. The display method according to claim 1, further comprising
receiving information related to directivity of the speakers or the microphones, wherein
the placement distribution is calculated further based on the information related to the directivity.

6. The display method according to claim 1, further comprising
calculating a sound pressure distribution corresponding to the placement distribution, and
displaying the sound pressure distribution.

7. The display method according to claim 1, further comprising
receiving the number and positions of fixed speakers or fixed microphones that are fixed in the acoustic space, wherein
the placement distribution is calculated further based on the number and positions of the fixed speakers or the fixed microphones.

8. An information processing device comprising:
a processor configured to
receive an acoustic space and a target sound pressure distribution in the acoustic space,
calculate, based on a prescribed model, a placement distribution of speakers or microphones, which corresponds to the target sound pressure distribution, in the acoustic space, and
display the placement distribution.

9. The information processing device according to claim 8, wherein
the placement distribution indicates the number and positions of the speakers or the microphones in the acoustic space.

10. The information processing device according to claim 8, wherein
the placement distribution includes output characteristics of the speakers or input characteristics of the microphones.

11. The information processing device according to claim 8, wherein
the acoustic space includes a first space for specifying the target sound pressure distribution, and a second space for installing the speakers or the microphones.

12. The information processing device according to claim 8, wherein
the processor is further configured to receive information related to directivity of the speakers or the microphones, and
the processor is configured to calculate the placement distribution further based on the information related to the directivity.

13., The information processing device according to claim 8, wherein
the processor is further configured to calculate a sound pressure distribution corresponding to the placement distribution, and display the sound pressure distribution.

14. The information processing device according to claim 8, wherein
the processor is further configured to receive the number and positions of fixed speakers or fixed microphones that are fixed in the acoustic space, and
the processor is configured to calculate the placement distribution further based on the number and positions of the fixed speakers or the fixed microphones.

15. A non-transitory computer-readable medium storing a program that causes a processor of an information processing device to execute a process, the process comprising:
receiving an acoustic space and a target sound pressure distribution in the acoustic space;
calculating, based on a prescribed model, a placement distribution of speakers or microphones, which corresponds to the target sound pressure distribution, in the acoustic space that has been received; and
displaying the placement distribution.
